(19) United States
(12) Patent Application Publication
(10) Pub. No.: US 2011/0051319 A1
(43) Pub. Date: Mar. 3, 2011

(54) CONDUCTING POLYMER MEMBRANE, METHOD OF MANUFACTURING CONDUCTING POLYMER MEMBRANE, AND ELECTRONIC DEVICE

(75) Inventors: Kaori ISHIKAWA, Nishinomiya City (JP); Gaku HARADA, Kawanishi City (JP)

(73) Assignee: SANYO ELECTRIC CO., LTD., Moriguchi City (JP)

(21) Appl. No.: 12/869,195

(22) Filed: Aug. 26, 2010

(30) Foreign Application Priority Data
Aug. 31, 2009 (JP) 2009-200701

(51) Int. Cl. H01G 9/00; H01B 1/12; B05D 5/12

(52) U.S. Cl. 361/523; 252/500; 427/79

(57) ABSTRACT

An oxidizer liquid containing an oxidizer, a surfactant substance, and an additive comprising a dopant anion and a cation derived from a basic substance is applied onto a base member. Then, this is exposed to a vapor of a precursor monomer of a conducting polymer. After that, the monomer of the conducting polymer is chemically polymerized on the base member.

### CROSS REFERENCE TO RELATED APPLICATIONS

This application claims the benefit of priority under 35 U.S.C §119 to the prior Japanese Patent Application No. P2009-200701 entitled “CONDUCTING POLYMER MEMBRANE, METHOD OF MANUFACTURING CONDUCTING POLYMER MEMBRANE, AND ELECTRONIC DEVICE” filed on Aug. 31, 2009, the entire contents of which are incorporated herein by reference.

### BACKGROUND OF THE INVENTION

1. Field of the Invention

The invention relates to a conducting polymer membrane, a method of manufacturing a conducting polymer membrane, and an electronic device.

2. Description of Related Art

Conducting polymers have characteristics of flexibility, lightness, and the like while having metal-like electrical conductivity or semi-conductivity. By taking advantage of the characteristics, the conducting polymers are used in the fields of antistatic materials, cathode materials for solid electrolyte capacitors, electromagnetic wave shielding materials, transparent electrode materials, and the like. Moreover, researches have been conducted to apply the conducting polymers to organic electroluminescent devices (organic EL devices), capacitors, transistors, solar cells, sensors, anti-rust materials, and the like.

Particularly, when a conducting polymer is applied to an electronic device as a cathode material for a solid electrolyte capacitor, a transparent electrode material of a touch panel in which a display function and a switch function are combined, or the like, a membrane made of such a conducting polymer (a conducting polymer membrane) needs to have a high electrical conductivity. For this reason, introduction of various dopants and additives to such a membrane has been examined.

In addition, particularly when a conducting polymer membrane is used as a transparent electrode of an electronic device, the membrane needs to have a uniform membrane thickness, and a flat and smooth surface.

Against such a background, three techniques have now been proposed for the purpose of improving the electrical conductivity of the conducting polymer. The three techniques are (1) addition of an organic solvent, (2) addition of a basic compound, and (3) addition of an acidic substance, as an additive.

As the first technique, Patent Document 1 (Japanese Patent No. 2916098) proposes a technique in which an organic solvent such as N-methylpyrrolidone or ethylene glycol is added to a conducting polymer including a polythiophene and a polyanion.

As the second technique, Patent Document 2 (Japanese Patent Application Publication No. 2007-95506) proposes addition of a basic electrical conductivity improver to a conducting polymer including a conducting polymer and a polyanion. Patent Document 3 (Japanese Patent Application Publication No. 2008-171761) and Non-Patent Document 1 (Advanced Functional Materials 2004, 14, No. 6, June, p. 615-622) propose oxidative polymerization with a basic electrical conductivity improver being added to a precursor monomer of a conducting polymer.

Moreover, as the third technique, Patent Document 4 (Japanese Patent Application Publication No. 2004-107552) and Patent Document 5 (Japanese Patent Application Publication No. 2008-34440) propose oxidative polymerization with an acidic additive such as para-toluenesulfonic acid or an aromatic dicarboxylic acid being added to a precursor monomer of a conducting polymer.

### SUMMARY OF THE INVENTION

An aspect of the invention provides a conducting polymer membrane that is obtained by chemically polymerizing a monomer of a conducting polymer by using any one of an oxidizer liquid and a polymerization liquid, wherein the any one of the oxidizer liquid and the polymerization liquid comprises: a surfactant substance; and an additive comprising: a dopant anion; and a cation derived from a basic substance.

The dopant anion is an acidic anion, and examples thereof include anions having a sulfonate group, a carboxylate group, a phosphate group, a phosphonate group, and the like. A compound is preferable in which the functional group of such an anion is bonded to benzene or naphthalene. It is preferable that the dopant anion is one of benzene derivative and naphthalene derivative. Moreover, the cation derived from the basic substance is preferably a cation that has characteristics as a base, i.e., characteristics of functioning in a pair with an acid, and that is produced when a nitrogen-containing aromatic heterocyclic compound, an amide group-containing compound, or an imide group-containing compound is ionized. In other words, a cation derived from one of these compounds is preferable. It is preferable that the cation derived from a basic substance is one of pyridine derivative and imidazole derivative. It is also preferable that the additive is pyridinium para-toluenesulfonate.

In the case of the thus obtained conducting polymer membrane, even when the oxidizer liquid or the polymerization liquid is an aqueous solution, the surfactant substance contained lowers the surface tension, so that the oxidizer liquid can be uniformly applied on a substrate. Accordingly, it is possible to obtain a conducting polymer membrane having a uniform film thickness. Moreover, the reaction rate of the conducting polymer is decelerated by adding the additive to the oxidizer liquid or the polymerization liquid. Hence, it is possible to improve the level of doping into the conducting polymer and the orientation of the conducting polymer. As a result, the electrical conductivity of the conducting polymer membrane can be increased. In addition, because the salt is used, the oxidizing ability of the oxidizer is not lowered. As a result, it is possible to obtain a conducting polymer membrane having a sufficient membrane thickness.

A method of manufacturing a conducting polymer membrane comprises: applying an oxidizer liquid onto a substrate, the oxidizer liquid containing an oxidizer, a surfactant substance, and an additive; exposing the substrate to a vapor of a precursor monomer of a conducting polymer; and chemically polymerizing the monomer of the conducting polymer on the substrate. Here, a salt described below, i.e., a salt comprising a dopant anion and a cation derived from a basic substance, is used as the additive.

Meanwhile, another method of manufacturing a conducting polymer membrane comprises: applying a polymerization liquid onto a substrate, the polymerization liquid containing a precursor monomer of a conducting polymer, an oxidizer, a surfactant substance, and an additive; and chemically polymerizing the monomer of the conducting polymer on the substrate. Here, a salt described below, i.e., a salt comprising a dopant anion and a cation derived from a basic substance, is used as the additive.

The additive is represented by the following general formula:

A⁻.B⁺ [Chemical Formula 1]

where A is a dopant anion, and B is a cation derived from a basic substance.

An electronic device is characterized by using the above-described conducting polymer membrane. Examples of the electronic device include a solid electrolyte capacitor, an organic EL device, an organic solar cell, an organic transistor, a touch panel, a battery, and the like. The electronic device can achieve a higher performance when the conducting polymer membrane is used as an organic membrane which needs to be electrically conductive in the electronic device. In addition, it is also useful to use the conducting polymer membrane as an electrode of the electronic device.

A solid electrolyte capacitor, which is the electronic device, comprises: an anode; a dielectric layer formed on a surface of the anode; a conducting polymer layer formed on the dielectric layer; and a cathode layer formed on the conducting polymer layer, wherein the conducting polymer membrane is used in at least a part of the conducting polymer layer. In the solid electrolyte capacitor as described above, the conducting polymer membrane excellent in electrical conductivity can be used in at least a part of the conducting polymer layer formed on the dielectric layer. Hence, characteristics of the capacitor, such as the capacitance and the ESR, can be improved.

### BRIEF DESCRIPTION OF THE DRAWINGS

FIGS. 1A to 1D are process diagrams showing a method of manufacturing a conducting polymer membrane.

FIGS. 2A to 2C are process diagrams showing another method of manufacturing a conducting polymer membrane.

FIG. 3 is a schematic cross-sectional view showing a solid electrolyte capacitor, which is an example of an electronic device.

FIG. 4 is a schematic cross-sectional view showing an organic solar cell, which is an example of the electronic device.

FIG. 5 is a schematic cross-sectional view showing a crystalline solar cell, which is an example of the electronic device.

FIG. 6 is a schematic cross-sectional view of a touch panel, which is an example of the electronic device.

FIG. 7 is a graph showing the relationship between a molar ratio of an additive mixed to an oxidizer and an electrical conductivity.

FIG. 8 is a table showing the evaluation results of the comparative examples 1 to 3 and examples 1 to 8.

### DETAILED DESCRIPTION OF EMBODIMENTS

Embodiments of the invention are explained with reference to the drawings. In the respective drawings referenced herein, the same constituents are designated by the same reference numerals and duplicate explanation concerning the same constituents is omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

In general, an electrical conductivity σ of a membrane made of a conducting polymer is represented by the following equation: σ=enμ, where e represents the charge, n represents the carrier density, and μ represents the mobility. Accordingly, the electrical conductivity σ can be increased by increasing the values of the carrier density n and the mobility μ.

An examination conducted by the inventors revealed that, in order to obtain a high electrical conductivity σ, it is important that the value of the carrier density n be increased by adding a dopant having a high carrier transport ability, and that it is further important to increase the value of the mobility μ by improving the orientation of the conducting polymer membrane.

Accordingly, Patent Documents 1 and 2 have a disadvantage that the orientation of the conducting polymer cannot be improved because the conducting polymer is first formed, and then the treatment with the additive is performed thereon. Meanwhile, regarding Patent Documents 4 and 5, the reaction rate is accelerated, when the hydrogen ion exponent (pH) of the oxidative polymerization solution is lowered (i.e., is shifted to the acidic side), in general. This lowers the degree of the orientation of a conducting polymer membrane obtained when the acidic additive is added to the precursor monomer of the conducting polymer. From this viewpoint, the orientation of the conducting polymer membrane is not improved by the above-described conventional technique, and hence carriers cannot move within molecular chains or between molecular chains efficiently. Accordingly, the improvement in the electrical conductivity by the above-described conventional technique cannot be expected. Regarding Patent Document 3 and Non-Patent Document 1, if a basic additive is added to decelerate the polymerization rate, a conducting polymer membrane with a high degree of orientation can be obtained. However, since the addition of the basic substance decelerates the reaction rate, it is difficult to obtain a conducting polymer membrane having a sufficiently large thickness.

Meanwhile, there are many methods of forming a thin membrane of a conducting polymer, such as chemical polymerization, electrolytic polymerization, and a method in which a ready-made conducting polymer is dispersed in a medium, and then formed into a membrane. However, in consideration of drawbacks in production, such as load of production facilities and a considerable time required for the formation of the membrane, the most industrially advantageous method is a method in which a conducting polymer membrane is formed by performing chemical polymerization on a substrate. In this respect, for forming a conducting polymer membrane on a substrate by chemical polymerization, there are: a method in which a polymerization liquid made of an oxidizer and a precursor monomer is applied on a substrate, and then polymerized, a method in which an oxidizer liquid is applied on a substrate, and then polymerization is performed by exposing the substrate to a vapor of a monomer, and other methods. In the case of any one of these methods, in order to form a flat and smooth thin membrane, the polymerization liquid or the oxidizer liquid needs to be uniformly applied onto the substrate.

However, there is a disadvantage as described below. Specifically, suppose a case where the polymerization liquid or the oxidizer liquid is applied onto a substrate of glass or the like by the spin coating method, the dip coating method, or the like. In such a case, if the liquid is an aqueous solution, the surface tension is so high that the wettability of the liquid on the substrate is poor. Hence, the liquid is repelled by the substrate, and the liquid cannot be spread uniformly over the substrate. For this reason, there is a certain limitation in obtaining a conducting polymer membrane having a uniform membrane thickness and a high electrical conductivity, and an electronic device using the same.

The conducting polymer membrane of an embodiment is obtained by chemically polymerizing a monomer of the conducting polymer by use of an oxidizer liquid or a polymerization liquid containing a surfactant substance, an additive (i.e., an additive which is a salt comprising a dopant anion and a cation derived from a basic substance).

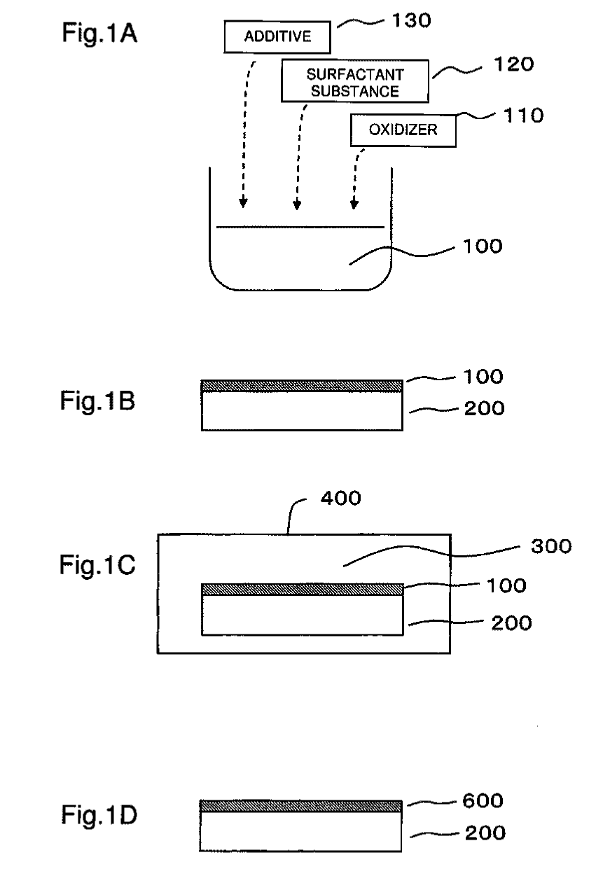

FIGS. 1A to 1D show a method of manufacturing a conducting polymer membrane of the embodiment in order of processing. Note that FIGS. 1A to 1D show an example in which a chemical polymerization of the conducting polymer membrane is performed on a base member (a substrate in this embodiment).

First, as shown in FIG. 1A, liquid oxidizer mixture 100 containing oxidizer 110, surfactant substance 120, additive 130 which is a salt comprising a dopant anion and a cation derived from a basic substance is prepared. In this embodiment, approximately 0.5 g of an aqueous mixture solution containing 20% by weight of hydrogen peroxide and 1% by weight of sulfuric acid is used as oxidizer 110. Meanwhile, 575 mg of sodium dodecyl sulfate is used as surfactant substance 120. In addition, 447 mg of pyridinium para-toluenesulfonate (hereinafter referred to as pyridinium p-toluenesulfonate) is used as additive 130. Additive 130 is a salt comprising a p-toluenesulfonate anion which serves as a dopant anion, and a cation (so called a pyridinium cation) derived from pyridine, which is a basic substance.

Next, as shown in FIG. 1E, oxidizer liquid 100 is applied onto substrate 200 by the spin coating. Application conditions in this embodiment are as follows. A glass substrate (approximately 30 mm square) is used as substrate 200. The number of spin revolutions is 1000 rpm. The duration of the spin is 30 seconds. The drying condition after the application is at room temperature (25° C.), and the drying duration is 5 to 10 seconds.

Next, as shown in FIG. 1C, substrate 200 onto which liquid oxidizer mixture 100 is applied is placed in sealed chamber 400 filled with a vapor of precursor monomer 300 of the conducting polymer. This causes liquid oxidizer mixture 100 applied onto substrate 200 to be exposed to the vapor of precursor monomer 300 of the conducing polymer. As a result, chemical polymerization proceeds on substrate 200. This reaction (chemical polymerization) gives a membrane made from a monomer of the conducting polymer, i.e., conducting polymer membrane 600. In this embodiment, a vapor of pyrrole is used as the vapor of precursor monomer 300. The conditions of the exposure in this case are at room temperature (25 degrees), for 20 minutes, without pressurization.

As a result, conducting polymer membrane 600 formed on substrate 200 is obtained as shown in FIG. 1D. In the case of this embodiment, the characteristics of thus obtained conducting polymer membrane 600 made from pyrrole are as follows: the membrane thickness is 0.12 μm, and the electrical conductivity is 0.734 S/cm.

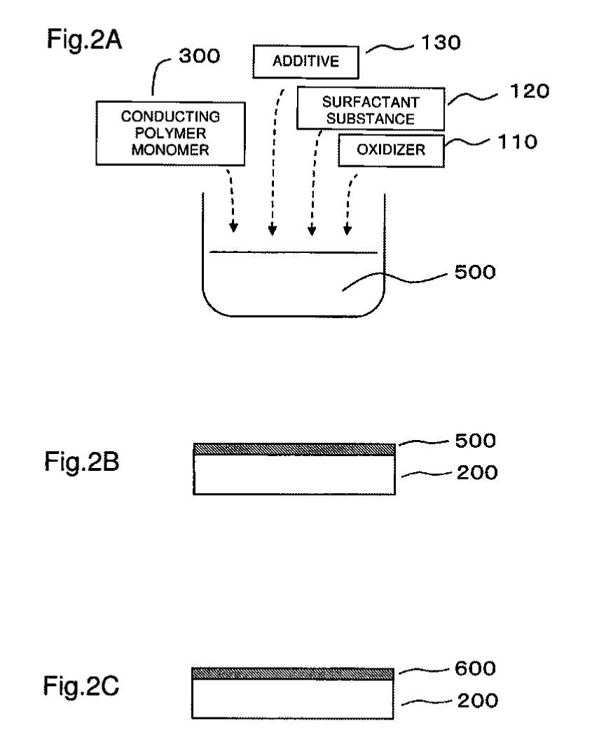

Next, FIGS. 2A to 2C show another method of manufacturing a conducting polymer membrane in order of processing. FIGS. 2A to 2C show an example in which a chemical polymerization of the conducting polymer membrane is performed on a base member (a substrate in this embodiment), as in the case of FIGS. 1A to 1D.

As shown in FIG. 2A, polymerization liquid 500 containing precursor monomer 300 of the conducting polymer, oxidizer 110, surfactant substance 120, and additive 130 which is a salt comprising a dopant anion and a basic substance is prepared. In the case of this embodiment, 147 mg of pyrrole is used as precursor monomer 300 of the conducting polymer. Approximately 0.5 g of an aqueous mixture solution of 20% by weight of hydrogen peroxide and 1% by weight of sulfuric acid is used as oxidizer 110. In addition, 57.5 mg of sodium dodecyl sulfate is used as surfactant substance 120. Moreover, 447 mg of pyridinium p-toluenesulfonate is used as additive 130.

Next, polymerization liquid 500 is applied onto substrate 200 by the spin coating as shown in FIG. 2B. In the case of this embodiment, polymerization liquid 500 prepared (mixed) as shown in FIG. 2A needs to be applied immediately after the preparation. The application conditions at this time are as follows. A glass substrate (approximately 30 mm square) is used as substrate 200. The number of spin revolutions is 1000 rpm. The duration of spin is 30 seconds. Regarding the environment of polymerization after the application, 30 minutes is required at room temperature (25° C.). Thereafter, substrate 200 is washed by immersion into pure water (10 to 20 seconds), and dried at 50° C. for 5 minutes.

As a result, conducting polymer membrane 600 formed on substrate 200 is obtained as show in FIG. 2C. The characteristics of thus obtained conducting polymer membrane 600 made from pyrrole are as follows: The membrane thickness is 0.21 μm, and the electrical conductivity is 0.65 S/cm.

Hereinafter, each component is described in further details.

<Additive>

The salt in this embodiment is represented by the above-described general formula, and an example of the additive is pyridinium p-toluenesulfonate. The reaction rate of the conducting polymer is decelerated by adding the additive to the polymerization solution for the conducting polymer. Hence, it is possible to improve the level of doping into the conducting polymer and the orientation of the conducting polymer. As a result, the electrical conductivity of the conducting polymer membrane can be increased.

In addition, since it is conceivable that the additive has a function of stabilizing the pH of the polymerization solution, the reaction rate of the conducting polymer can be kept in a constant decelerated state. Accordingly, the level of doping into the conducting polymer and the orientation thereof can be improved, and the electrical conductivity of the conducting polymer membrane can be increased. Moreover, since the additive is a salt, the additive does not deteriorate the oxidizing ability of the oxidizer. Accordingly, it is possible to easily obtain a conducting polymer membrane having a thickness practical for use in devices.

Accordingly, the additive in this embodiment has a function of decelerating the reaction rate, and a function of stabilizing the reaction rate. It is conceivable that the electrical conductivity is improved because the additive improves the orientation, crystallinity, and denseness of the conducting polymer membrane.

In obtaining a conducting polymer by chemically polymerizing a polymerizable monomer of polypyrrole, polyethylenedioxythiophene (abbreviated as PEDOT) or the like, it is known that the lower the pH of the polymerization solution, the faster the polymerization rate. As the polymerization rate becomes faster, the membrane quality and orientation of the conducting polymer are deteriorated. As a result, the electrical conductivity is lowered.

In this respect, in conventional techniques, a basic substance such as pyridine or imidazole is added to raise the pH of the polymerization solution in a case of an additive for improving the electrical conductivity. Thereby, the oxidizing effect of the oxidizer is reduced, and the reaction rate is decelerated. In this case, as the amount of the basic substance added is increased, the oxidizing ability of the oxidizer is lowered, and hence the polymerization becomes less likely to occur. As a result, it becomes impossible to obtain a conducting polymer membrane having a sufficient membrane thickness.

The effect of the additive seems to be a deceleration effect on the reaction in the chemical polymerization (hereinafter referred to as a reaction deceleration effect). Although the details of the reaction deceleration effect is unclear, the presence of the deceleration effect on the polymerization reaction is supported by the fact that the membrane thickness of the obtained conducting polymer decreases more than that expected to be caused by the decrease in the monomer concentration due to the addition of the additive. The deceleration of the reaction rate improves the orientation, crystallinity, and denseness of the conducting polymer membrane. In addition, because the salt is used, the oxidizing ability of the oxidizer is not lowered. As a result, it is possible to obtain a conducting polymer membrane having a sufficient membrane thickness.

In this embodiment, the content of the additive in the oxidizer liquid for the conducting polymer is preferably in a range of 0.05 mol to 2.0 mol per mole of the oxidizer, although the preferable content depends on the kinds of the oxidizer and the additive. If the content of the additive is too small, the effect of excelling in the electrical conductivity is not obtained sufficiently in some cases. Meanwhile, if the content of the additive is too large, the polymerization deceleration effect becomes stronger. As a result, the conducting polymer membrane tends to be thinner, and it tends to be difficult to obtain a sufficiently large membrane thickness. Moreover, when the conducting polymer membrane is formed, for example, on a glass substrate, the surface activity may be lowered, and the conducting polymer membrane may attach to the substrate ununiformly. A further preferable range of the content of the additive is 0.1 mol to 0.6 mol, and more preferably 0.2 mol to 0.5 mol when the membrane is formed on glass substrate 200 with hydrogen peroxide used as the oxidizer, and pyridinium p-toluenesulfonate used as the additive, for example.

<Monomer of Conducting Polymer>

Examples of conducting polymer monomer 300 used in this embodiment include pyrrole, thiophene, aniline, and derivatives thereof. A n conjugated conducting polymer having a repeating unit of the monomer can be obtained by polymerization of the monomer. Accordingly, by using the above-described monomers, conducting polymers made of, for example, polypyrroles, polythiophenes, polyanilines, copolymers thereof, and the like can be obtained. A sufficient electrical conductivity can be obtained without substitution on the n conjugated conducting polymer. However, in order to further increase the electrical conductivity, a functional group such as an alkyl group, a carboxylate group, a sulfonate group, an alkoxyl group, a hydroxyl group, a cyano group, or the like is preferably introduced into the n conjugated conducting polymer.

Specific examples of the n conjugated conducting polymer include polypyrrole, poly(N-methylpyrrole) poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3,4-ethylenedioxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-anilinesulfonic acid), poly(3-anilinesulfonic acid), and the like. Among those, a (co) polymer made of one kind or two kinds selected form polypyrrole, polythiophene, poly(N-methylpyrrole), poly(3-methylthiophene), poly(3-methoxythiophene), and poly(3,4-ethylenedioxythiophene) is preferably used from the viewpoint of electrical conductivity. Moreover, polypyrrole, and poly(3,4-ethylenedioxythiophene) are more preferable from the viewpoints of further increase in electrical conductivity and improvement in heat resistance.

<Oxidizer>

Oxidizer 110 in this embodiment is preferably one used as a polymerization initiator for the monomer of the conducting polymer. As the oxidizer, any known oxidizer can be used, and examples thereof include peroxy acids and salts thereof, such as hydrogen peroxide, ammonium persulfate, and sodium perborate; transition metal compounds such as iron (III) sulfate and iron (III) nitrate; transition metal salts of organic sulfonic acid, such as iron p-toluenesulfonate; and the like. In this embodiment, even when the oxidizer liquid is an aqueous solution, the surfactant substance contained lowers the surface tension, so that the oxidizer liquid can be uniformly applied on the substrate. For this reason, it is unnecessary to use an organic solvent, and water, which is non-combustible and relatively safe, can be used as the solvent. In addition, the oxidizer can be selected from a wider range, because even oxidizers which are soluble only in water can be used.

<Additive>

As the additive in this embodiment, a salt represented by the following general formula can be used:

A⁻.B⁺ [Chemical Formula 2]

where A is a dopant anion, and B is a cation derived from a basic substance.

A is preferably an acidic anion. From such a viewpoint, a sulfonate group, a carboxylate group, a phosphate group, or a phosphonate group is preferably contained. More preferably, A is an anion of a compound in which any one of the functional groups is bonded to benzene or naphthalene.

Meanwhile, regarding B, the cation derived from the basic substance is a cation having characteristics as a base, i.e., characteristics of functioning in a pair with an acid. Preferable is a cation produced when a nitrogen-containing aromatic heterocyclic compound, an amide group-containing compound, or an imide-containing compound is ionized, i.e., a cation derived from one of these compounds.

Particularly when a nitrogen-containing aromatic heterocyclic compound is used for cation B, examples of the nitrogen-containing aromatic heterocyclic compound include pyridines and derivatives thereof, which have one nitrogen atom; imidazoles, derivatives thereof, pyrimidines, derivatives thereof, pyrazines, and derivatives thereof, which have two nitrogen atoms; triazines and derivatives thereof, which has three nitrogen atoms; and the like. From the viewpoint of solubility in a solvent, pyridines, derivatives thereof, imidazoles, derivatives thereof, pyrimidines, and derivatives thereof are preferable.

Specific substances usable as cation B are listed below. Specific examples of pyridines and derivatives thereof include pyridine, 2-methylpyridine, 3-methylpyridine, 4-methylpyridine, 4-ethylpyridine, 3-butylpyridine, 4-tert-butylpyridine, 2-butoxypyridine, 2,4-dimethylpyridine, 2-fluoropyridine, 2,6-difluoropyridine, 2,3,5,6-tetrafluoropyridine, 2-vinylpyridine, 4-vinylpyridine, 2-methyl-6-vinylpyridine, 5-methyl-2-vinylpyridine, 4-butenylpyridine, 4-pentenylpyridine, 2,4,6-trimethylpyridine, 3-cyano-5-methylpyridine, 2-pyridinecarboxylic acid, 6-methyl-2-pyridinecarboxylic acid, 2,6-pyridinedicarboxylic acid, 4-pyridinecarboxyaldehyde, 4-aminopyridine, 2,3-diaminopyridine, 2,6-diaminopyridine, 2,6-diamino-4-methylpyridine, 4-hydroxypyridine, 2,6-dihydroxypyridine, methyl 6-hydroxynicotinate, 2-hydroxy-5-pyridinemethanol, ethyl 6-hydroxynicotinate, 4-pyridinemethanol, 4-pyridineethanol, 2-phenylpyridine, 3-methylquinoline, 3-ethylquinoline, quinolinol, 2,3-cyclopentenopyridine, 2,3-cyclohexanopyridine, 1,2-di(4-pyridyl)ethane, 1,2-di(4-pyridyl)propane, 2-pyridinecarboxyaldehyde, 2-pyridinecarboxylic acid, 2-pyridinecarbonitrile, 2,3-pyridinedicarboxylic acid, 2,4-pyridinedicarboxylic acid, 2,5-pyridinedicarboxylic acid, 2,6-pyridinedicarboxylic acid, 3-pyridinesulfonic acid, and the like.

Specific examples of imidazoles and derivatives thereof include imidazole, 2-methylimidazole, 2-ethylimidazole, 2-propyl imidazole, 2-isopropylimidazole, 2-butylimidazole, 2-undecylimidazole, 2-heptadecylimidazole, 2-phenylimidazole, N-methylimidazole, N-vinyl imidazole, N-allylimidazole, 2-methyl-4-vinyl imidazole, 2-methyl-1-vinylimidazole, 1-(2-hydroxyethyl)imidazole, 2-ethyl-4-methylimidazole, 1,2-dimethylimidazole, 1-benzyl-2-methylimidazole, 1-benzyl-2-phenylimidazole, 1-cyanoethyl-2-methylimidazole, 1-cyanoethyl-2-ethyl-4-methylimidazole, 2-phenyl-4,5-dihydroxymethylimidazole, 1-acetylimidazole, 4,5-imidazoledicarboxylic acid, dimethyl 4,5-imidazoledicarboxylate, benzimidazole, 2-aminobenzimidazole, 2-aminobenzimidazole-2-sulfonic acid, 2-amino-1-methylbenzimidazole, 2-hydroxybenzimidazole, 2-(2-pyridyl)benzimidazole, 2-nonylimidazole, carbonyldiimidazole, and the like.

Specific examples of pyrimidines and derivatives thereof include 2-amino-4-chloro-6-methylpyrimidine, 2-amino-6-chloro-4-methoxypyrimidine, 2-amino-4,6-dichloropyrimidine, 2-amino-4,6-dihydroxypyrimidine, 2-amino-4,6-dimethylpyrimidine, 2-amino-4,6-dimethoxypyrimidine, 2-aminopyrimidine, 2-amino-4-methylpyrimidine, 4,6-dihydroxypyrimidine, 2,4-dihydroxypyrimidine-5-carboxylic acid, 2,4,6-triaminopyrimidine, 2,4-dimethoxypyrimidine, 2,4,5-trihydroxypyrimidine, 2,4-pyrimidinediol, and the like.

Specific examples of pyrazines and derivatives thereof include pyrazine, 2-methylpyrazine, 2,5-dimethylpyrazine, pyrazinecarboxylic acid, 2,3-pyrazinecarboxylic acid, 5-methylpyrazinecarboxylic acid, pyrazinamide, 5-methylpyrazinamide, 2-cyanopyrazine, aminopyrazine, 3-aminopyrazine-2-carboxylic acid, 2-ethyl-3-methylpyrazine, 2-ethyl-3-methylpyrazine, 2,3-dimethylpyrazine, 2,3-diethylpyrazine, and the like.

Specific examples of triazines and derivatives thereof include 1,3,5-triazine, 2-amino-1,3,5-triazine, 3-amino-1,2,4-triazine, 2,4-diamino-6-phenyl-1,3,5-triazine, 2,4,6-triamino-1,3,5-triazine, 2,4,6-tris(trifluoromethyl)-1,3,5-triazine, 2,4,6-tri-2-pyridine-1,3,5-triazine, 3-(2-pyridine)-5,6-bis(4-phenylsulfonic acid)-1,2,4-triazine disodium salt, 3-(2-pyridine)-5,6-diphenyl-1,2,4-triazine, 2-hydroxy-4,6-dichloro-1,3,5-triazine, and the like.

Specific examples of other nitrogen-containing aromatic heterocyclic compounds include indole, 1,2,3-benzotriazole, 1H-benzotriazole-1-methanol, and the like.

Here, specific examples of the salt used as the above-described additive are shown below: pyridinium p-toluenesulfonate, 2-aminoethanethiol-p-toluenesulfonic acid salt, aminomalononitrile-p-toluenesulfonic acid salt, phenylalanine benzyl ester-p-toluenesulfonic acid salt, 2,6-dimethylpyridinium p-toluenesulfonate, 2,4,6-trimethylpyridinium p-toluenesulfonate, 2-chloro-1-methylpyridinium p-toluenesulfonate, 2-fluoro-1-methylpyridine-p-toluenesulfonate, pyridinium 3-nitrobenzenesulfonate, 1-cyclohexyl-3-(2-morpholinoethyl) carbodiimide metho-p-toluenesulfonate, glycine benzyl ester p-toluenesulfonate, hexyl 6-aminohexanoate p-toluenesulfonate, β-alanine benzyl ester p-toluenesulfonate, D-alanine benzyl ester p-toluenesulfonate, D-leucine benzyl ester p-toluenesulfonate, D-valine benzyl ester p-toluenesulfonate, L-alanine benzyl ester p-toluenesulfonate, L-leucine benzyl ester p-toluenesulfonate, L-tyrosine benzyl ester p-toluenesulfonate, propionyl p-toluenesulfonate, tetramethylammonium p-toluenesulfonate, tetraethylammonium p-toluenesulfonate, tosufloxacin p-toluenesulfonate, 1-ethyl-3-methylimidazolium p-toluenesulfonate, imidazolium salts, pyrrolidinium salts, pyridinium salts, ammonium salts, phosphonium salts, sulfonium salts, and the like.

In addition, the above-described salts may be used with other dopants such as protonic acids including sulfuric acid, nitric acid, and hydrochloric acid.

In this embodiment, the content of the additive in the oxidizer liquid for the conducting polymer is preferably in a range of 0.05 mol to 2.0 mol per mole of the oxidizer, although the preferable content depends on the kinds of the oxidizer and the additive. If the content of the additive is too small, the effect of excelling in the electrical conductivity is not obtained sufficiently in some cases. Meanwhile, if the content of the additive is too large, the polymerization deceleration effect becomes stronger. As a result, the conducting polymer membrane tends to be thinner, and it tends to be difficult to obtain a sufficiently large membrane thickness. Moreover, when the conducting polymer membrane is formed, for example, on a glass substrate, the surface activity may be lowered, and the conducting polymer membrane may attach to the substrate ununiformly. A further preferable range of the content of the additive is 0.1 mol to 0.6 mol, and more preferably 0.2 mol to 0.5 mol when the membrane is formed on a glass substrate with hydrogen peroxide used as the oxidizer, and pyridinium p-toluenesulfonate used as the additive, for example.

<Surfactant>

As surfactant 120 to be contained in the oxidizer liquid, a surfactant of any one of anionic, cationic, zwitterionic, and nonionic types can be used. Those whose anions can contribute as a dopant of the conducting polymer, such as alkali salts of higher fatty acids, alkyl sulfate salts, alkyl sulfonate salts, and alkyl aryl sulfonate salts are particularly preferable from the viewpoint of provision of electrical conductivity to the conducting polymer membrane.

Regarding the content of surfactant 120, a content which satisfies a condition under which the oxidizer liquid is not repelled by the substrate, and can spread in a uniform thickness depends on the critical micelle concentration (CMC) of the surfactant. For example, in a case of sodium dodecyl sulfate, the content is preferably 0.01 mol/L or higher, and more preferably 0.1 mol/L to 0.5 mol/L.

<Base Member>

In this embodiment, the substrate on which the conducting polymer membrane is formed does not necessarily have a plate-like shape, and the shape thereof is not particularly limited. Accordingly, the base member may be any, as long as the base member serves as a base on which the conducting polymer membrane is formed, for example, in an electronic device having the conducting polymer membrane. Hereinafter, it should be understood that when the term “base member” is used, the meaning of a substrate is included.

As a method of forming the conducting polymer membrane on the base member, a method may be employed in which the polymerization liquid containing the precursor monomer of the conducting polymer, the oxidizer, and the additive is applied on the base member, and then the monomer of the conducting polymer in the polymerization liquid is polymerized. The method of applying the polymerization liquid on the base member is not particularly limited, and examples thereof include the spin coating method, the dip coating method, the drop casting method, the ink-let method, the spray method, the screen printing method, the gravure printing method, the flexo printing, and the like.

Since the conducting polymer membrane can be obtained by polymerizing the monomer of the conducting polymer on the base member, there is an effect of improving the adhesion between the base member and the conducting polymer membrane, in comparison with a case where the monomer of the conducting polymer is first polymerized, and then the polymerized product is applied onto the substrate.

<Solid Electrolyte Capacitor>

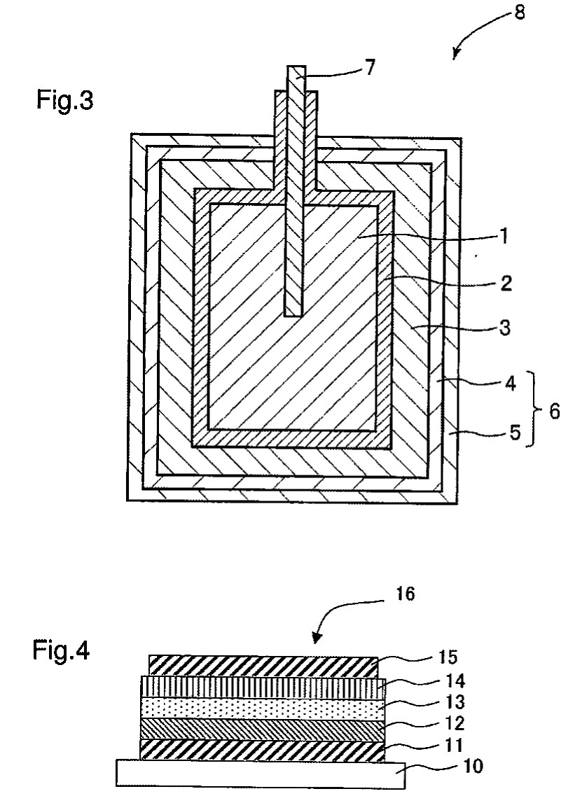

Devices to which the conducting polymer membrane is applied include a solid electrolyte capacitor. FIG. 3 is a schematic cross-sectional view showing an example of the solid electrolyte capacitor. As shown in FIG. 3, one end of anode lead 7 is buried in anode 1. Anode 1 is fabricated by shaping a powder made of a valve metal or an alloy mainly containing a valve metal, and then sintering the shaped body. Accordingly, anode 1 is formed of a porous member. Although not shown in FIG. 3, many fine pores are formed in the porous member and communicate from the inside thereof to the outside thereof. Thus fabricated anode 1 has an outer shape of a substantially rectangular parallelepiped. Examples of the valve metal used for the anode of the capacitor include tantalum, niobium, titanium, aluminum, hafnium, zirconium, and the like. Among these, tantalum, niobium, aluminum, or titanium, whose dielectric oxide is relatively stable even at high temperature, is preferably used. The alloy mainly containing a valve metal may be an alloy of two or more kinds of valve metals, such as tantalum with niobium.

Dielectric layer 2 made of an oxide is formed on a surface of anode 1. Dielectric layer 2 is formed also on surfaces of the pores of anode 1. FIG. 3 schematically shows dielectric layer 2 formed on the outer peripheral side of anode 1, but does not show the above-described dielectric layer formed on the surfaces of the pores of the porous material. Dielectric layer 2 can be formed by anodizing the surface of anode 1.

Conducting polymer layer 3 having the conducting polymer membrane (corresponding to 600 in FIGS. 1 and 2) of this embodiment is formed on the surface of the dielectric layer 2. Conducting polymer layer 3 is formed also on dielectric layer 2 on the surfaces of the pores of anode 1.

Carbon layer 4 is formed on conducting polymer layer 3 on the outer peripheral surface of anode 1. Silver paste layer 5 is formed on carbon layer 4. Carbon layer 4 and silver paste layer 5 constitute cathode layer 6. Carbon layer 4 can be formed by applying a carbon paste, and then drying the carbon paste. Silver paste layer 5 can be formed by applying a silver paste, and then drying the silver paste. As described above, solid electrolyte capacitor 8 is constructed.

In general, in solid electrolyte capacitor 8 as shown in FIG. 3, a mold resin covers a periphery thereof, an anode terminal is connected to anode lead 7, and a cathode terminal (not illustrated) is connected to cathode layer 6. Each of the terminals is provided in such a manner as to be led out to the outside of the mold resin (not illustrated). In solid electrolyte capacitor 8, at least a part of conducting polymer layer 3 can be formed of the conducting polymer membrane 600. The use of conducting polymer membrane 600 makes it possible to form conducting polymer layer 3 excellent in electrical conductivity.

As described above, the conducting polymer membrane is obtained by using anode 1 as the base member, and chemically polymerizing the monomer of the conducting polymer on anode 1, which is the base member. Accordingly, the adhesion with the substrate is improved, in comparison with a case where the monomer of the conducting polymer is polymerized, and then the polymerized product is applied on the substrate. For this reason, the contact resistance is reduced, and the ESR is improved.

Particularly in forming a first conducting polymer layer on the dielectric layer by using a membrane formation method, a porous dielectric pellet is used as the base member (corresponding to 200 in FIG. 1). Accordingly, when the base member is immersed in a liquid oxidizer mixture (100 in FIG. 1) containing the surfactant and the additive, the oxidizer liquid can be caused to uniformly penetrate into the inside of the pores of the dielectric layer. When this base member is exposed to a vapor of pyrrole as shown in FIG. 1C, a conducting polymer layer excellent in electrical conductivity can be filled into the inside of the pores of the dielectric layer. Note that the pH of the liquid oxidizer mixture in this case can be adjusted to 4 to 9.

Conducting polymer layer 3 thus formed can increase the capacitance of solid electrolyte capacitor 8, and reduce the ESR thereof.

In the case of the solid electrolyte capacitor as the electronic device, the electrical conductivity of the conducting polymer layer can be improved, and hence a solid electrolyte capacitor having a high capacitance and a low ESR can be obtained.

<Organic Solar Cell>

An organic solar cell is one of electronic devices to which the conducting polymer membrane is applied. FIG. 4 is a schematic cross-sectional view showing an example of the organic solar cell. As shown in FIG. 2, transparent electrode 11 is formed on substrate 10. A glass substrate can be used as substrate 10. A thin film made of indium-tin oxide (ITO) or the like is formed as transparent electrode 11. Hole transporting layer 12 is formed on transparent electrode 11. The conducting polymer membrane can be formed as hole transporting layer 12. Active layer 13 is formed on hole transporting layer 12. For example, a membrane of poly(3-hexylthiophene) can be formed as active layer 13. Electron transporting layer 14 is formed on active layer 13. For example, a film of C60 fullerene or the like can be formed as electron transporting layer 14. Upper electrode 15 is formed on electron transporting layer 14. For example, a film of a metal such as aluminum can be formed as upper electrode 15. As described above, organic solar cell 16, which is an example of this embodiment, is constructed.

In organic solar cell 16, the conducting polymer membrane is used as hole transporting layer 12. Specifically, by using transparent electrode 11 as a base member, and forming hole transporting layer 12 made of the conducting polymer membrane on the base member, it is possible to form hole transporting layer 12 excellent in electrical conductivity on transparent electrode 11.

As described above, hole transporting layer 12 is capable of improving the electrical conductivity. Hence, the IR drop attributable to the interface resistance and the bulk resistance can be reduced, and the open-circuit voltage of the solar cell can be increased.

<Silicon-Based Solar Cell>

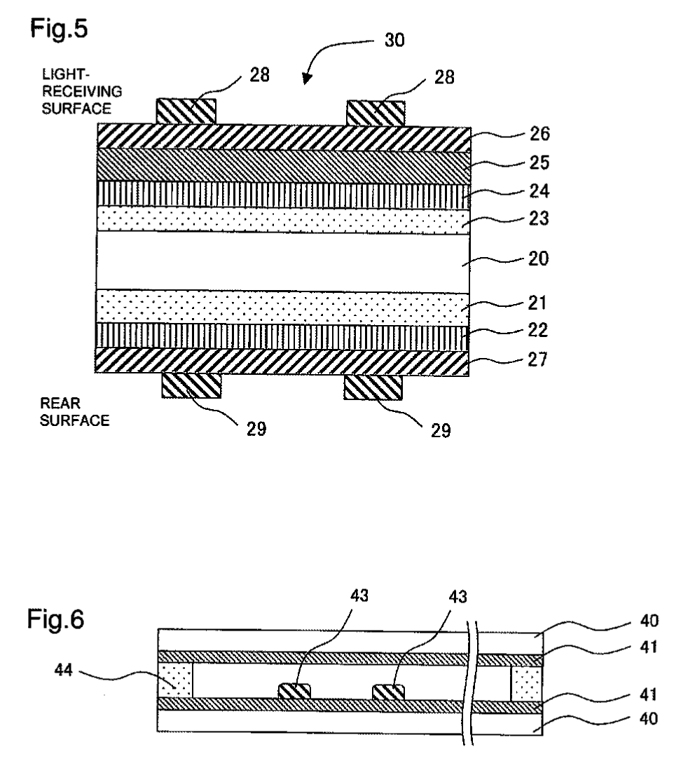

FIG. 5 is a schematic cross-sectional view showing silicon-based solar cell 30 of another example of the device according to this embodiment. As shown in FIG. 5, on a rear surface side of n-type single-crystal silicon substrate 20 having texture structures on surfaces thereof, i-type amorphous silicon layer 21, n-type amorphous silicon layer 22 are formed in this order. On a light-receiving surface side thereof, i-type amorphous silicon layer 23 and p-type amorphous silicon layer 24 are formed in this order.

On p-type amorphous silicon layer 24 on the light-receiving surface side, conducting polymer membrane 25 is formed as a transparent electrode. On conducting polymer membrane 25, buffer layer 26 is formed. As buffer layer 26, indium-tin oxide (ITO) can be used. In addition, rear surface electrode layer 27 is formed on n-type amorphous silicon layer 22 on the rear surface side. As rear surface electrode layer 27, indium-tin oxide (ITO) can be used. Light-receiving surface side collector electrodes 28 are formed on buffer layer 26 on the light-receiving surface side. Rear surface side collector electrodes 29 are formed on rear surface electrode layer 27. As described above, silicon-based solar cell 30, which is another example of this embodiment, is constructed.

In silicon-based solar cell 30, which is the example of this embodiment, conducting polymer membrane 25 is formed as the transparent electrode on the light-receiving surface side.

Accordingly, the thickness of the membrane can be reduced to such an extent that light can be sufficiently transmitted therethrough. As a result, silicon-based solar cell 30 can include an electrode excellent in electrical conductivity and light transparency.

As described above, it is possible to improve the electrical conductivity of the transparent electrode on the light-receiving surface side in the silicon-based solar cell, which is the electronic device. Hence, the loss due to the resistance of the transparent electrode can be reduced in the silicon-based solar cell, and the conversion efficiency of the solar cell can be raised.

<Other Examples of Electronic Device>

As other examples of the electronic device, the conducting polymer can be used as a transparent electrode when formed on a base member such as a transparent substrate or membrane.

As another example of the electronic device, a touch panel in which display function and a switch function are combined is described below.

FIG. 6 shows the touch panel. However, what is illustrated is a switch function portion, and no display function portion is illustrated. The display function portion is disposed to overlap the lower surface side of the illustrated switch function portion so that switch positions of the switch function portion can correspond to display positions of the display function portion. Note that FIG. 6 shows an example in which the touch panel detects a touch position by the resistance film method.

The touch panel of FIG. 6 uses conducting polymer membranes 41 of this embodiment. Specifically, two conducting polymer membranes 41 are formed on two film substrates 40, respectively, to form transparent conducting substrates. The transparent conducting substrates 40 are pasted to each other with a paste (not illustrated), while conducting polymer membranes 41 face to each other and are spaced from each other at a constant distance. In this case, film substrates 40 are used as base members, and conducting polymer membranes 41 are formed on the base members through the manufacturing process as shown in FIGS. 1A to 1D or 2A to 2C.

In the touch panel of FIG. 6, dot spacers 43 made of insulative members are disposed between the conducting polymer membranes 41 facing to each other. Many dot spacers are dispersedly disposed on a plane so as to keep the space between two conducting polymer membranes 41 disposed to face each other. Accordingly, when no pressure is applied to the touch panel, spacers 43 prevent conducting polymer membranes 41 from coming into contact with each other, which would otherwise occur due to warp of film substrates 40.

In the touch panel, a pressure is applied to a top surface of upper film substrate 40 by a pen, a finger, or the like, the pressing force makes conducting polymer membranes 41 come into contact with each other at the pressing position. As a result, upper and lower conducting polymer membranes 41 are in contact with each other, and becomes electrically continuous with each other. At this time, the plan position of the point of contact can be found by detecting the values of resistance from a position of contact of conducting polymers 41 to positions of predetermined multiple end portions of conducting polymer membranes 41.

Besides the application in electronic devices such as a solid electrolyte capacitor, the conducting polymer membrane also has its application in transparent electrodes of optical devices such as the above-described touch panel, a display, a light-emitting device. Accordingly, the electronic device may be an optical device.

### Example

Hereinafter, specific Examples are described in detail. However, the invention is not limited to Examples below.

### Formation of Conducting Polymer Membrane on Glass Substrate

### Examples 1 to 7

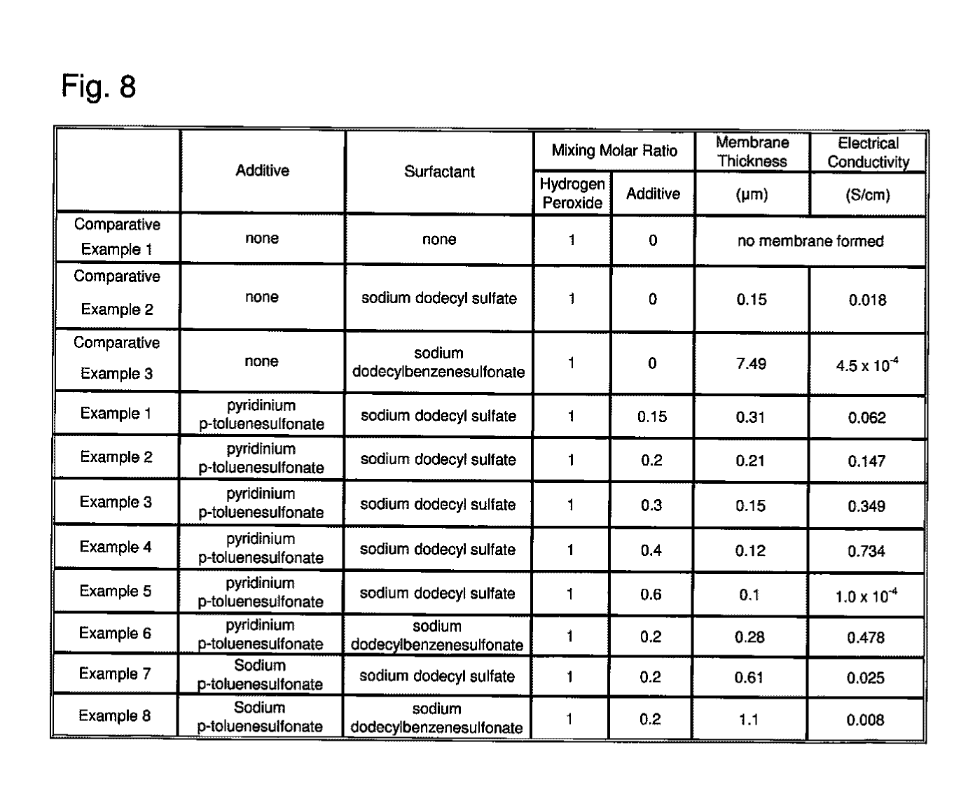

A surfactant is added to an aqueous mixture solution, of 20% by weight of hydrogen peroxide and 1% by weight of sulfuric acid, which are an oxidizer and a dopant, so as to be 10.3% by weight (0.25 mmol/L). Then, the solution is mixed with an additive at a predetermined molar ratio shown in FIG. 8. Thus, an oxidizer liquid of each Example is prepared.

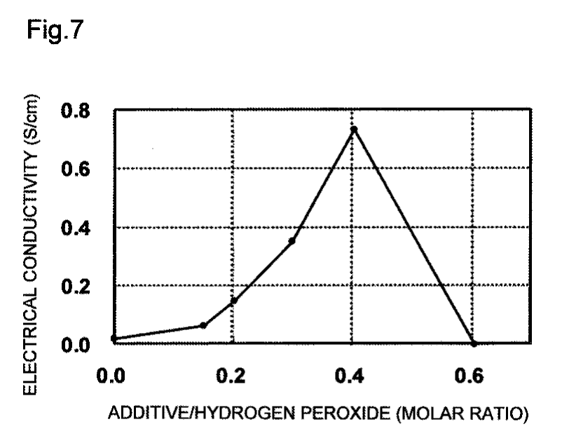

The thus obtained oxidizer liquid is applied to a glass substrate by the spin coating method so as to form a membrane. The substrate is placed in a sealed container filled with pyrrole, which is a precursor monomer of a conducting polymer, and exposed to a vapor of pyrrole for 20 minutes. Thereafter, the substrate is taken out of the container, and stood at room temperature for approximately 5 minutes. Then, the membrane is washed with pure water to remove by-products. Thus, a conducting polymer membrane is formed on the glass substrate. The sectional area in the thickness direction of the thus obtained conducting polymer membrane, and the length of the conducting polymer membrane are measured. The membrane thickness is measured by using a stylus-type surface-profile measurement instrument Dektak, and the electrical conductivity of the conducting polymer membrane is measured by a resistivity meter Lorester MCP-T610 (manufactured by Dia Instruments Co. Ltd.). The following FIGS. 7 and 8 show the evaluation results.

Each mixing molar ratio shown in FIGS. 7 and 8 shows the molar ratio of the additive to hydrogen peroxide, which is the oxidizer, with hydrogen peroxide taken as 1.

### Comparative Example 1

A spin coating membrane formation is attempted on a glass substrate under conditions similar to those of Examples, except that an aqueous mixture solution of 20% by weight of hydrogen peroxide and 1% by weight of sulfuric acid alone is used as the oxidizer liquid. However, the oxidizer liquid is respelled by the substrate, and cannot be spread uniformly. Hence, no conducting polymer membrane having a uniform membrane thickness is formed.

### Comparative Examples 2 and 3

A conducting polymer membrane of each of Comparative Examples 2 and 3 is formed in a similar manner to that of Examples, except that an oxidizer liquid used is prepared by adding a surfactant to an aqueous mixture solution of 20% by weight of hydrogen peroxide and 1% by weight of sulfuric acid, so that the surfactant can be 10.3% by weight (0.25 mol/L). The electrical conductivity of the conducting polymer membrane is evaluated, and the evaluation results are shown in FIGS. 7 and 8.

As shown in FIG. 8, the use of the oxidizer liquid to which the surfactant is added according to the above-described embodiment makes it possible to form a uniform conducting polymer membrane on a glass substrate. Moreover, the conducting polymer membrane of each of Examples 1 to 4, and 6 formed by adding pyridinium p-toluenesulfonate as the additive to the oxidizer liquid has a higher electrical conductivity than its counterpart in Comparative Example 2 or 3 where no additive is added. Regarding the results obtained by examination in which the amount of the additive is varied, when the molar ratio of hydrogen peroxide, which is the oxidizer, to the additive is 1:0.4, the highest electrical conductivity is obtained. This means that the electrical conductivity is improved approximately 40-fold with respect to Comparative Example 2 where no additive is added. However, the electrical conductivity of the membrane is markedly lowered at a molar ratio of 1:0.6. This shows that, when the oxidizer is hydrogen peroxide, the molar ratio of the oxidizer to the additive has an influence on the magnitude of the effect of improving the electrical conductivity. Particularly, it is found out from FIG. 7 that a molar ratio of 1:0.2 to 1:0.55 is a preferable mixing ratio, and a molar ratio of 1:0.3 to 1:0.5 is a further preferable range.

Note that the electrical conductivity is improved in Examples 7 and 8 where in place of pyridinium p-toluenesulfonate, sodium p-toluenesulfonate, which is a metal salt having the same anion species, is added to the oxidizer liquid, in comparison with Comparative Examples 2 and 3 where no additive is added. However, sodium p-toluenesulfonate is less effective than pyridinium p-toluenesulfonate.

This indicates that, among additives having the same anion species, an additive having a cation derived from a basic substance has a larger effect of improving the electrical conductivity, and hence more suitable than an additive having a cation derived from an alkali metal ion.

As have been described above, according to Examples, it is possible to form a conducting polymer membrane having a uniform membrane thickness and an excellent electrical conductivity even in the case of the hydrogen peroxide oxidizer which is generally used as an aqueous solution.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A conducting polymer membrane obtained by chemically polymerizing a monomer of a conducting polymer by using any one of an oxidizer liquid and a polymerization liquid, wherein the any one of the oxidizer liquid and the polymerization liquid comprises:
a surfactant substance; and
an additive comprising:
a dopant anion; and
a cation derived from a basic substance.

2. The conducting polymer membrane of claim 1, wherein the additive is represented by the following general formula:
A⁻.B⁺
where A is the dopant anion, and B is the cation derived from a basic substance.

3. The conducting polymer membrane of claim 1, wherein
the dopant anion comprises at least one functional group selected from the group consisting of a sulfonate group, a carboxylate group, a phosphate group, and a phosphonate group.

4. The conducting polymer membrane of claim 1, wherein
the dopant anion is one of benzene derivative and naphthalene derivative.

5. The conducting polymer membrane of claim 1, wherein
the cation derived from a basic substance is a cation derived from a compound which is produced when at least one of a nitrogen-containing aromatic heterocyclic compound, an amide group-containing compound, and an imide group-containing compound is ionized.

6. The conducting polymer membrane of claim 1, wherein
the cation derived from a basic substance is a cation derived from a compound that is produced when one of pyridine derivative and imidazole derivative is ionized.

7. The conducting polymer membrane of claim 1, wherein
the additive is pyridinium para-toluenesulfonate.

8. An electronic device comprising the conducting polymer membrane of claim 1.

9. The electronic device of claim 8, wherein the electronic device is a solid electrolyte capacitor comprising:
an anode;
a dielectric layer formed on a surface of the anode;
a conducting polymer layer formed on the dielectric layer; and
a cathode layer formed on the conducting polymer layer,
wherein the conducting polymer membrane is used in at least a part of the conducting polymer layer.

10. A method of manufacturing a conducting polymer membrane comprising:
applying an oxidizer liquid onto a base member, the oxidizer liquid containing an oxidizer, a surfactant substance, and an additive comprising a dopant anion and a cation derived from a basic substance;
exposing the base member to a vapor of a precursor monomer of a conducting polymer; and
chemically polymerizing the monomer of the conducting polymer on the base member.

11. The method of manufacturing a conducting polymer membrane of claim 10, wherein
the additive is represented by the following general formula:
A⁻.B⁺
where A is the dopant anion, and B is the cation derived from a basic substance.

12. The method of manufacturing a conducting polymer membrane of claim 10, wherein
the dopant anion comprises at least one functional group selected from the group consisting of a sulfonate group, a carboxylate group, a phosphate group, and a phosphonate group.

13. The method of manufacturing a conducting polymer membrane of claim 10, wherein
the dopant anion is one of benzene derivative and naphthalene derivative.

14. The method of manufacturing a conducting polymer membrane of claim 10, wherein
the cation derived from a basic substance is a cation derived from a compound which is produced when at least one of a nitrogen-containing aromatic heterocyclic compound, an amide group-containing compound, and an imide group-containing compound is ionized.

15. A method of manufacturing a conducting polymer membrane of claim 10, wherein
the cation derived from a basic substance is one of pyridine derivative and imidazole derivative.

16. A method of manufacturing a conducting polymer membrane of claim 10, wherein
the additive is pyridinium para-toluenesulfonate.

17. A method of manufacturing a conducting polymer membrane comprising:
applying a polymerization liquid onto a base member, the polymerization liquid containing a precursor monomer of a conducting polymer, an oxidizer, a surfactant substance, and an additive comprising a dopant anion and a cation derived from a basic substance; and
chemically polymerizing on the base member the monomer of the conducting polymer in the polymerization liquid.

18. A method of manufacturing a conducting polymer membrane of claim 17, wherein
the additive is represented by the following general formula:
A⁻.B⁺
wherein A is the dopant anion used for the conducting polymer, and B is the cation derived from the basic substance.
